(19) United States
(12) Patent Application Publication
(10) Pub. No.: US 2005/0138032 A1
(43) Pub. Date: Jun. 23, 2005

(54) Network based client-server communications

(76) Inventors: Thomas O'Rourke, Galway (IE); Kevin Gallagher, Galway (IE); Keith Griffin, Waterford (IE)

Correspondence Address: BARNES & THORNBURG, P.O. BOX 2786, CHICAGO, IL, 60690-2786, US

(21) Appl. No.: 10/741,516

(22) Filed: Dec. 19, 2003

(51) Int. Cl. G06F 17/30

(52) U.S. Cl. 707/10

(57) ABSTRACT

A client accesses an application provided on a server using web services to formulate appropriate commands to the application. The client additionally downloads from the server its own web services provider, and the server maintains an application to consume services provider by the client-side provider. In this way, the server is provided with the ability to issue to the client commands which can be interpreted by the client as event notifications and messages. In this way, web services can be used in parallel streams to be provide unsolicited event messaging from the client to the server and vice versa. This has particular application in the provision of a computer telephone integration (CTI) client which needs to receive unsolicited events messaging relating to a telephony device under its control.

### TECHNICAL FIELD

This invention relates to the provision of communications between client and server applications over a network. The invention has particular application in the provision of computer-telephone integration (CTI) services to a client.

### BACKGROUND ART

Computer telephone integration is increasingly used to provide a telephony user with better control over a telephony device, such as a telephone or computer-implemented softphone.

As is well known in the art, computer telephony integration allows a user having both a telephone and a computer to employ applications running on the computer (such as address books, telephone number directories, customer relationship management software, call centre agent interface software, etc.) in conjunction with a telephone at their desk. To give just one example, when a call is connected through to an agent in a call centre, the agent's computer work station can be caused to display to the agent customer history details, account information, associated emails, etc. based on telephony/communications parameters and customer inputs in combination with contact centre databases, to provide the agent with a better understanding of the nature of the call. Similarly, if an agent wishes to make a call to a customer, one can dispense with a conventional telephone handset and provide the agent simply with a headset connected to the private branch exchange (PBX). The agent can access the details of the party to be called in a customer details database and by selecting a “call customer” icon, CTI software will instruct the PBX to make a call from the agent's extension (headset) to the requested number. By integrating the computer system at the call centre with the PBX and telephone network, better control is provided to the agent and additional reporting and management tools are available for the call centre management.

Most CTI applications employ a client-server architecture, where the user is provided with client software, and the client software interacts with a CTI application provided on the server. The CTI application, in turn, controls the PBX. A fundamental requirement for a piece of CTI client software is that it not only can issue outgoing commands to the server, but that it also can receive unsolicited event notifications from the server. For example, if a call is made to the agent's extension, this is an event which must be notified to the CTI client software. Similarly, if a call is disconnected by a remote party, the updated status of the agent's extension should be reflected in the CTI user interface of the agent.

This requirement of allowing unsolicited event notifications to be delivered to the client software means that a network connection must be kept open between the client and server so that the client is listening on a particular port for event notifications arriving from the server. This causes a difficulty to network administrators who are reluctant to bypass firewalls or to open additional connections to either the client or the server. Such open ports provide the possibility of virus infection or malicious attacks on the network. Given that the agent computer may be accessing databases in which sensitive financial or other information is stored, it is a significant disadvantage of any CTI application if it requires additional open ports.

A further disadvantage is that as the software is updated it must be deployed to each desktop in order to properly integrate the client-server interface. In organisations with large numbers of CTI users this imposes a significant overhead on the IT department.

While most computers already have secured and trusted ports open to a network, in the form of browsers which access the company Intranet or the Internet, standard Internet-based communications methods do not provide for unsolicited event notification. When a user accesses a web-based resource, a request is sent to a uniform resource indicator or URI (normally a domain name which is tied to an Internet protocol (IP) address). In the case of a browser, this request is a request to download a web page. The server at the requested address responds with hypertext mark-up language (HTML) code which is interpreted in the browser and displayed on screen as a web page. It is also possible to download other codes, such as JavaScript (JavaScript is a Trademark of Sun MicroSystems) and this additional code can run within the browser. It would be possible, for example, to download a JavaScript application or a Java Applet which would open additional ports, but this again leads to the same problem of firewall security.

While it would be desirable to provide a web based CTI application which did not open any additional communications ports other than those already secured by a standard Internet connection, such CTI applications are not currently available.

### DISCLOSURE OF THE INVENTION

The invention provides a method of providing a client computer with remote access to an application controlled by a server across a data network without maintaining a dedicated communications channel between the client and the server. The method includes the steps of:
a) providing a network addressable server-side service which can control the application in response to predefined commands received by the server over the network;
b) providing a definition of the application control commands, the definition being accessible over the data by a client so that the client can provide an interface which formulates the predefined commands and address the commands to the server-side service in response to user inputs;
c) providing instructions accessible by the client which define a client-side service which executes one or more predefined procedures to generate notifications on the client in response to notification commands received by the client over the network; and
d) providing on the server an interface between the application and the data network which is effective to issue one or more of the notification commands in response to notifications of events received from the application;
   whereby the server-side service provides a control service to enable the client to control the application, and the client-side service provides a notification service to enable the server to notify the client of events occurring in the application.

In effect, therefore, this method allows the server both to run services which the client can access to control a server-side application, and to provide the client with the means to run services which the server can access to notify the client of events occurring in the application. In this way, asynchronous events can be notified in both directions by invoking services, and this can be accomplished without maintaining a dedicated communications channel.

A dedicated communications channel in the sense used above is a connection-oriented link between the client and server which remains open while the interaction takes place. In contrast, the present invention allows asynchronous events notifications to be made in a connectionless manner with no requirement to maintain an open link between the client and server. By addressing commands to either the client-side service or the server-side service, one can effectively send commands or event notifications asynchronously.

In this way, a browser type interface (or a client employing a browser mechanism to access services across the web, with or without a browser GUI being presented to the user) can asynchronously send commands or events using standard (connectionless) Internet-type connections. Similarly, such a browser interface can receive events notifications or commands as services provided on the client are addressed by the server, again without the necessity for dedicated connections to remain open.

Preferably, both the server-side and client-side services are each provided as web services between a provider and a remote consumer, the consumer of the server-side service being the client interface and the consumer of the client-side service being the server interface.

Further, preferably, the definition of the application control commands is a web services description language (WSDL) file provided on the server.

The WSDL file may include the instructions which define the client-side web service.

Alternatively, the WSDL file may include instructions for the client to access the instructions which define the client-side web service over the network.

Thus, the client, on receiving the WSDL file, may either directly implement its own services, or may follow a URL to a downloadable definition of its own services.

It will be appreciated that either method provides the advantage that the server “knows” (having provided the instructions for the client-side service to be implemented) the full details of the client-side service and therefore the server can invoke the client side service features without the normal downloading of a WSDL file.

In a particularly preferred embodiment, the application is a computer telephone integration (CTI) application in communication with a telephony network, whereby the interface on the client enables a user of the client to control a device on the telephony network and the interface on the server enables the CTI application to issue notifications of telephony network events or state changes relating to the device to the user of the client.

(It is to be understood that a telephony network in this sense includes both traditional networks such as the public switched telephone network or PSTN, and data networks which can carry telephony communications using protocols such as Voice over Internet Protocol (VoIP). It is also to be understood that telephony is meant to embrace both voice-only communications and alternative media type calls or mixed media communications such as video calls or conferences.)

Preferably, the data network is a packet switching network employing the transport communication protocol/internet protocol (TCP/IP) method of addressing packets from the client to the server and vice versa.

Most preferably, the data network is selected from a local area network (LAN), a wide area network (WAN), and the Internet.

In one implementation, the server is a web server running the application.

In another implementation, the server is a web server and the application runs on a computer in communication with the server.

The invention also provides a computer program product including a program which can be run on a computer causing the computer to carry out the method of the invention.

The computer program product can be an optical or magnetic carrier such as a disk storing the program, a hard disk or other memory device of a computer, an electrical signal (whether wireless or carried over a physical line) such as a program encoded for transmission over a network, or in any other suitable format to carry a program. The program product can also be an electronic circuit or firmware which embodies the computer program.

In another aspect the invention provides a server having control over an application and comprising a network connection for enabling the server to connect to a data network, and a storage area for storing instructions which when executed are effective to:
a) provide a network addressable server-side service which executes one or more predefined procedures to control the application in response to predefined application control commands received by the computer over the network;
b) provide a definition of the application control commands, the definition being accessible over the data network by a remote client to enable the remote client to provide an interface which formulates the predefined commands and addresses the commands to the server-side service in response to inputs to the client;
c) provide instructions accessible over the data network by the remote client which define a network addressable client-side service which executes one or more predefined procedures to generate notifications on the client in response to predefined notification commands received by the client over the network; and
d) provide on the computer an interface between the application and the data network which is effective to issue one or more of the notification generation commands in response to notifications of events received from the application;
   whereby the server-side service provides a network addressable control service to enable the client to control the application on the computer, and the client-side service provides a network addressable notification service to enable the server to notify the client of events occurring in the application, without maintaining a dedicated communications channel between the remote client and the computer.

The method as described above relates primarily to the steps carried out on the server side. In addition, the invention provides a method for the client side which will now be described.

Thus, the invention also provides a method of remotely controlling an application from a client computer across a data network, the application being under the local control of a server on the data network, without maintaining a dedicated communications channel between the client and the server, comprising the steps of:
a) receiving from the server a definition of application control commands which cause a network addressable server-side service to execute one or more predefined procedures to control the application;
b) providing on the client an interface based on the definition which formulates the predefined commands and addresses the commands to the server-side service in response to inputs to the client;
c) receiving instructions over the data network which define a network addressable client-side service which executes one or more predefined procedures to generate notifications on the client in response to predefined notification commands received by the client over the network; and
d) providing on the client the network addressable client-side service which monitors for receipt of the notification generation commands and which generates the notifications on the client in response thereto;
   whereby the server-side service provides a network addressable control service to enable the client to control the application on the server, and the client-side service provides a network addressable notification service to enable the server to notify the client of events occurring in the application.

In similar manner to the server-side program, the invention provides a computer program product including a program for implementing the client-side method.

The invention further provides a client computer for providing remote control over an application across a data network, comprising a network connection for enabling the client computer to connect to the data network, and a storage area for storing instructions which when executed are effective to cause the client to:
a) receive from a server across the network a definition of application control commands which cause a network addressable server-side service to execute one or more predefined procedures to control the application;
b) provide on the computer an interface based on the definition which formulates the predefined commands and addresses the commands to the server-side service in response to inputs to the computer;
c) receive instructions over the data network which define a network addressable client-side service which executes one or more predefined procedures to generate notifications on the computer in response to predefined notification commands received by the computer over the network; and
d) providing on the computer the network addressable client-side service which monitors for receipt of the notification generation commands and which generates the notifications on the computer in response thereto;
   whereby the server-side service provides a network addressable control service to enable the computer to control the application on the server, and the client-side service provides a network addressable notification service to enable the server to notify the computer of events occurring in the application, without maintaining a dedicated communications channel between the remote client and the computer.

In another aspect the invention provides a system comprising a client as defined above and a server as defined above connected across a data network.

The invention further provides a method of providing an asynchronous interaction between a client and a server, comprising the steps of providing Web Services on the server to be consumed by the client and providing Web Services on the client to be consumed by the server, whereby each of the client and server acts as both a Web Services provider and a Web Services consumer, such that when acting as a consumer each can notify the other of events asynchronously by invoking a Web Services command, and wherein the asynchronous interaction is provided without maintaining a dedicated communications channel.

### BRIEF DESCRIPTION OF DRAWINGS

FIG. 1 is a block diagram of a general architecture for implementing the present invention;

FIG. 2 is a block diagram of an architecture for implementing the present invention based on FIG. 1 but in greater detail;

FIG. 3 is a flowchart showing the operation of the method steps occurring on both the client-side and the server-side;

FIG. 4 is a schematic representation of the processes and files provided on the web server to implement the system of FIGS. 1 and 2;

FIG. 5 is a flowchart of the call control process between the client and server; and

FIG. 6 is a flowchart of the CTI events notification process between the server and client.

### DETAILED DESCRIPTION OF PREFERRED EMBODIMENTS

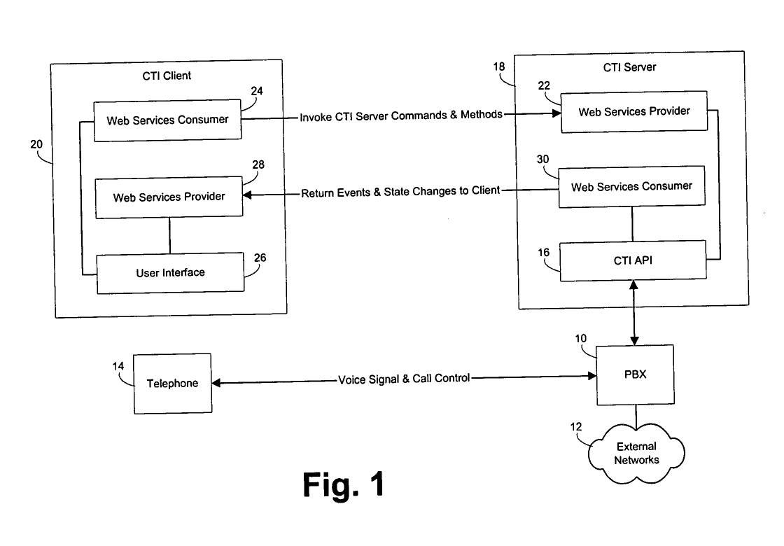

FIG. 1 shows a general architecture for implementing the present invention. A private branch exchange or PBX 10 is connected to external network 12 such as the public switched telephone network or the Internet (via a suitable gateway). Connected to the PBX 10 is a user's telephone 14. This may be a conventional telephone handset, or a headset, or an Ethernet phone which connects across a local area network. It can also be a software application on the user PC which in combination with a loudspeaker and microphone interface provides the functionality of a telephone set.

The PBX 10 is controlled by a computer telephone integration (CTI) application programming interface (API) 16 running in a CTI server 18. The CTI application 16 operates to translate commands received from telephony users into a suitable format to control the PBX to carry out a requested task. The CTI application also receives back from the PBX 10 event notifications such that the CTI application is provided with a real time overview of the current state of telephone device 14 and all other extensions under the control of the PBX 10.

The user of telephone device 14 is also provided with a computer which is shown for simplicity as a CTI client 20. The CTI client 20 will, in fact, be a piece of software running on a client computer (not shown). The CTI client 20 is connected to CTI server 18 across a local area network, a wide area network or the Internet. Communications between the client 20 and server 18 will now be described in overview before proceeding to provide a more detailed description. The communications are implemented using web services running on both the client and on the server.

Web services provide a platform independent method of publishing from a web server to a client (which runs a browser) a set of application control commands. The application control commands are formatted in a web services description language which are downloaded by the client. The client is then in possession of a description of all of the services being provided on the server and of the commands needed to access these services or to invoke methods provided by the server. Web services are often described in terms of the services provider (which runs on the server) and the services consumer (which runs on the client).

An advantage of the use of web services is that the client computer need not be configured in advance with a dedicated interface to the server. By downloading the web services description language (WSDL) file the client is provided with the necessary interface. The interface between the client and server is made via a normal Internet connection which can be secured using known and trusted security protocols such a secure sockets layers (SSL). Similarly, the commands issued by the client to the server are sent using the normal Internet connection to a web address which is specified in the WSDL file.

All that is required for the client to implement the web services is a component capable of requesting and interpreting WSDL files and of providing an interface between a web page displayed on the browser and the component which translates user actions (such as clicking on icons) into specified commands. Current conventional browsers such as Netscape (Netscape is a Trademark of Netscape Corporation) or Internet Explorer (Internet Explorer is a Trademark of Microsoft Corporation) are provided with the necessary functionality to implement web services. Indeed, web services are proposed as a standard method of allowing network access to a server application from a client by the World Wide Web Consortium (W3C).

As seen in FIG. 1, a web services provider 22 on the server 18 can receive CTI server commands and methods from a web services consumer 24 on the CTI client. This web services provider 22 passes the necessary commands to the CTI application 16. In this way, a user of the CTI client 20 can issue commands to control the PBX. The client 20 can include a graphical user interface 26 or it can be a “headless” application with no explicit user interface. Typically, this will enable the user to make calls, terminate calls, transfer calls, etc., and thus the user can employ the user interface to control his or her telephone 14. It will be readily appreciated by the skilled person that this also enables the user to access databases, address books and telephone directories in order to pass dialling instructions to the PBX which the PBX will use to connect the telephone 14 to the requested number.

In addition to the web services provided by the CTI server and consumed by the client, there is a further web services provider 28 provided on the CTI client 20. Web services provider 28 enables a web services consumer 30 provided on the CTI server 18 to control the user interface 26. The server-side consumer 30 monitors the CTI application 16 for event notifications relating to telephone 14, and returns events and state changes to the client in the form of commands accessing resources provided by the client-side web services provider 28. In this way, when an event or state change relating to telephone 14 is notified by the PBX 10 to the CTI API 16, this notification is transmitted in the form of a command from the server-side consumer 30 to cause the client-side provider 28 to update the user interface 26.

It will be appreciated, therefore, that by providing web services in parallel from both the server and the client, events, commands and messages can be transmitted in both directions between the client and the server. In effect, the client is caused to act as a “server” also but this is done using a web services interface across a standard Internet-type connection. There are no unconventional open ports and provided the browser is already secured across a firewall, no additional connections through the firewall need be made.

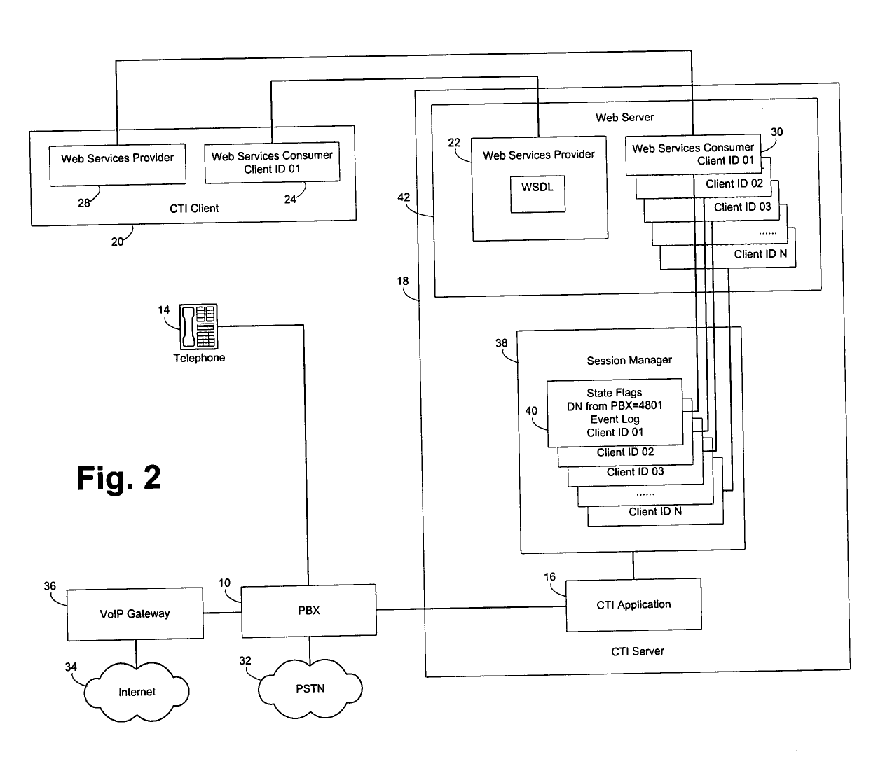

Referring now to FIG. 2, the same architecture will be shown in greater detail for an environment in which there are multiple users. As before, a telephone 14 is connected to a PBX 10 enabling calls to be made to external networks such as the PSTN 32 or the Internet 34 (via a voice over Internet protocol gateway 36). A CTI application 16 running on a CTI server 18 provides an interface between a web services consumer 24 provided on the client 20 and the PBX 10 via server-side web services provider 22 and CTI application 16. Similarly, a client-side web services provider 28 enables a service side web services consumer 30 to control the CTI application 16 in response to events and state changes issuing from PBX 10 via CTI application 16. FIG. 2 shows in addition that a session manager 38 is provided on the CTI server. Session manager 38 maintains a number of sessions 40, with each session monitoring for and controlling the interaction between a particular client 20 and the PBX, and maintaining a record of a particular telephony device(s) 14 under the control of that particular client 20.

In this way, when the PBX notifies the CTI application of a state change from a particular extension, this information is passed to the session manager 38 by the CTI application 16 and the session manager uses the extension or directory number of the particular telephone to identify the particular CTI client 30 which controls that device. The session manager also maintains an event log recording all of the commands, changes of state and event notification, and maintains state flags for the telephony device 14 to allow recovery in the event that the CTI client loses its connection to the CTI server but the CTI client needs to be re-launched.

In order to transmit event notification and state changes to the correct CTI client, each client interacts with a unique web services consumer 30 running on the server. As can be seen from FIG. 2, the server provides its web services provider 22 and consumers 30 from a web server which can either form part of CTI server 18 (as shown) or can be a separate dedicated web server.

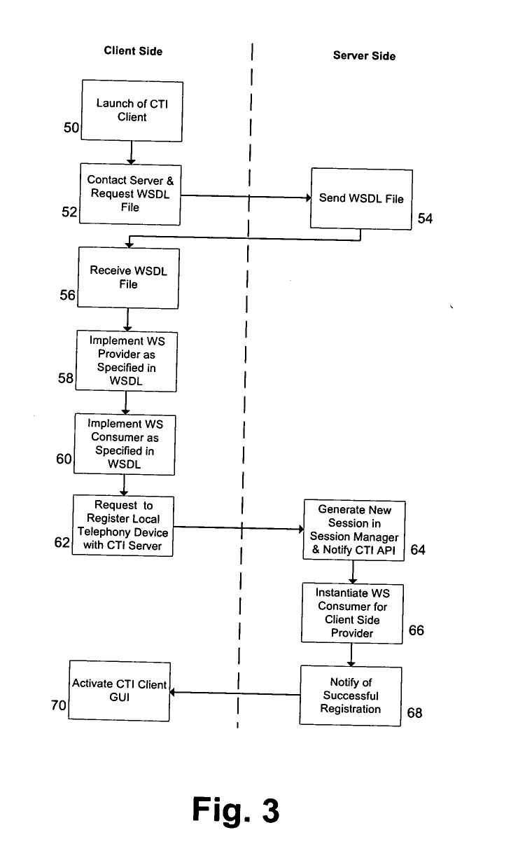

Referring now to FIG. 3, the operation of the system illustrated in FIGS. 1 and 2 will be explained in more detail. The flowchart of FIG. 3 shows the operation of the steps occurring on both the client-side and the server-side. A user launches the CTI client 20 on his or her computer, step 50. The client is configured with the address of the web server 42 and this configures to request a web services description language file 44 (see FIG. 2), step 52. The web server 42 sends the WSDL file, step 54 to the client. The WSDL file, in addition to defining the services provided by the server-side web services provider 22 and the commands which should issue from the client-side web services consumer 24, also includes a definition of how the client should implement its own web services provider. Normally, this definition will not be explicitly included in the web services description language, but will instead be provided as a pointer to a resource on the server 42, from which the client-side web services provider should be downloaded. When the client receives the web services description file, step 56, it implements its own web services provider 28, as specified in the web services description language file, step 58. It also uses the conventional information in the WSDL file to implement the client-side web services consumer, step 60.

The client-side web services provider 28 need not include its own web services description language file, since such files are normally only used by the consumer of the services to obtain an up to date definition of the services available and the commands required to access them. In the present case, the client will have received the details to implement the web services provider from the server, and therefore the server can already have its own server-side web services consumer definition available and this will, of necessity, be compatible with the services available from the client-side web services provider (since the client-side web services provider was supplied by or downloaded from the server).

The CTI client, after instantiating the client-side provider and consumer in steps 58 and 60, issues a request to register a local telephony device with the CTI server 16, step 62. In general, the identity of the local telephony device 14 will be stored by the CTI client, but it would also be possible for the user to identify, at the time of issuing the request in step 62, the device which is to be controlled. This is of benefit, in particular, where users are mobile and have wireless connections to the server, in which case a user can sit at any desk and take control over the telephone at that desk.

Upon receipt of this request, the server-side provider will pass the request to the session manager, which generates a new session 40 and notifies the CTI application 16 that it wishes to take control over the identified device, step 64.

When the session has been established in the session manager 38, the web server 42 generates an instance of the web services consumer 30 to interact with the client-side web services provider, step 66. The server-side consumer sends a notification to the client that the registration has been successful, step 68, and when this is received by the client-side provider, the CTI client activates the graphical user interface through which call control and event notifications will be made, step 70.

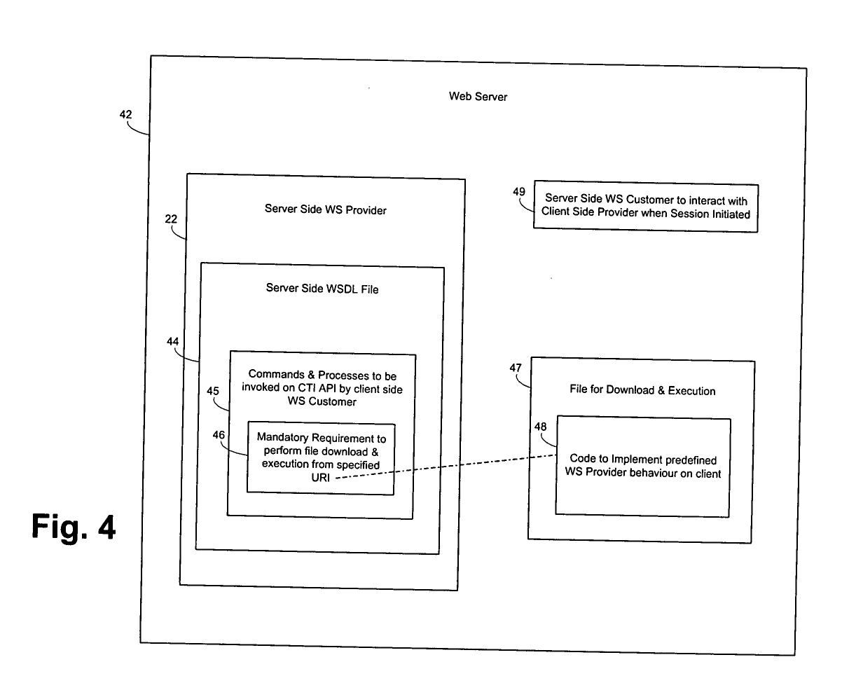

FIG. 4 provides a schematic representation of the processes and files needed on the web server to implement the system of FIGS. 1 and 2 as described above. The web server maintains a web services provider 22 which includes WSDL file 44. WSDL file 44 includes a definition 45 of the commands and processes which can be invoked on the CTI application by the client-side web services consumer. The WSDL file 44 also includes an instruction 46 to the CTI client as to where it will access its own web services provider. This is interpreted as a mandatory requirement by the CTI client to access a specified URI and download a file 47 which includes the code 48 necessary to implement a pre-defined web services provider behaviour on the client. In addition, the web server includes the definition 49 of the server-side web services consumer behaviours needed to interact with the client-side provider when the session has been initiated.

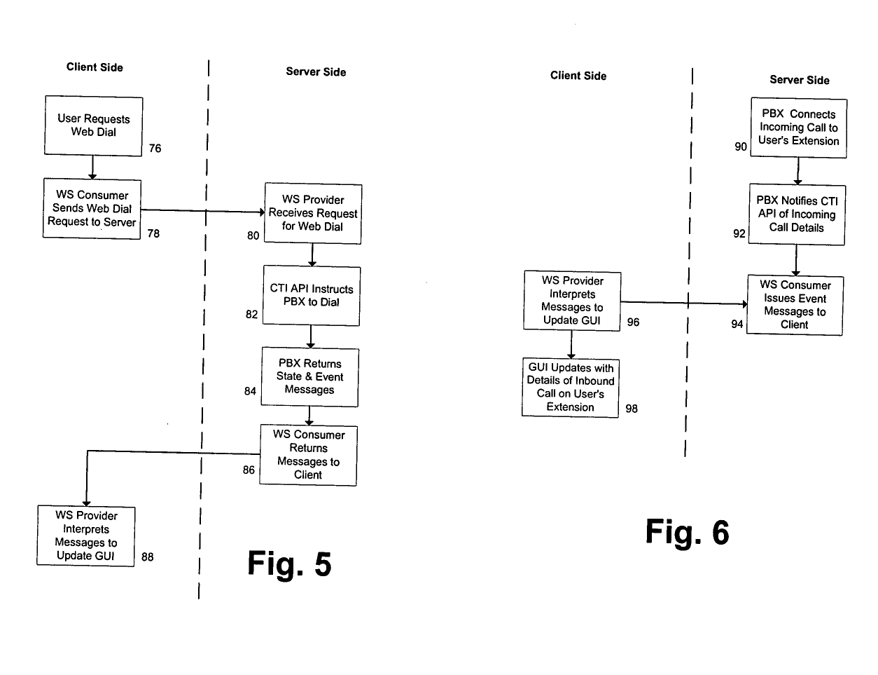

When the session has been established, call control can be effected between the client-side consumer and the server-side provider, as will be illustrated in FIG. 5, and events notifications and messages can be implemented between the server-side consumer and the client-side provider, as will be described in relation to FIG. 6. The examples given are for a simple call set up and for a notification of an incoming call, and the skilled person will appreciate that these two examples of communications in either direction are merely representative and can be extrapolated to any call function from the client to the server and any notification from the server to the client (or indeed vice versa).

In FIG. 4, a user wishes to make a phone call from a number which is stored on the client and using an appropriate command, menu item or icon, the user requests a web dial to this number, step 76. The web services consumer sends the web dial request to the server, step 78. On receipt, step 80, this request is passed via the session manager to the CTI application. The CTI application will therefore be provided with the identity of the telephony device 14, and the number to be dialled, and it will use this to generate a command to the PBX to dial the number, step 82.

As the PBX is dialling the number and when it makes the necessary connection (or fails to make the connection as the case may be) it returns appropriate state and event messages to the CTI application, step 84. The used messages are assigned by the session manager 38 to the appropriate session 40 and therefore the relevant server-side web services consumer 30 will formulate messages to the client based on the state and event messages issuing from the PDX, step 86. The client-side web services provider interprets these messages and passes them to the graphical user interface which thereby provides the user with a real time notification of the progress of the call, step 88.

FIG. 5 shows an example of an event which is not initiated by the user. The session will have been established between the client and server as described in relation to FIG. 3, but there will be no call in progress. An incoming call for the user's telephony device 14 can arrive directly (from a remote caller having the direct dial number of the extension), or can be held at the PBX and assigned to that extension by an operator or by an automated system such as a call Center queuing mechanism. In either case, the PBX connects the incoming call to the user's extension, step 90. The PBX simultaneously or very shortly afterwards notifies the CTI application 16 of the details of the incoming call, step 92. Such details will typically include the calling line identification of the calling party, from which other databases and processes can be queried for additional information, such as a name and address, an account history, etc., depending on the environment in which the system is being used.

The CTI passes the event notification of the incoming call and any additional details available to it to the session manager which notes the identity of the extension and thereby assigns this event notification to the relevant session. Notification is passed to the server-side web services consumer 30 which is interacting with the relevant client 16, and the web services consumer issues the event messages to the client-side web services provider 28, step 94.

The web services provider, on receipt of this unsolicited event notification, interprets this “request for services” as a command to update the graphical user interface, step 96. The graphical user interface will be updated with the details of the inbound call on the user's extension. This should occur very shortly after the phone begins to ring. The CTI client can then take additional steps, such as to provide screen pops of any additional information available to it and relevant to the user.

It will be appreciated that while the method described above is described in relation to a CTI environment, the concept of using parallel streams of services between a client and server over an internet type connection is equally applicable to other environments where there is a need to provide a client with access to a server based application and for the server based application to notify the client of unsolicited events and messages.

The invention is not limited to the embodiments described herein which can be modified or varied without departing from the scope and spirit of the claimed invention.

1. A method of providing a client computer with remote access to an application controlled by a server across a data network without maintaining a dedicated communications channel between the client and the server, comprising the steps of:
a) providing a network addressable server-side service which executes one or more predefined procedures to control said application in response to predefined application control commands received by the server over the network;
b) providing a definition of said application control commands, said definition being accessible over the data network by a client to enable the client to provide an interface which formulates said predefined commands and addresses said commands to the server-side service in response to inputs to the client;
c) providing instructions accessible over the data network by the client which define a network addressable client-side service which executes one or more predefined procedures to generate notifications on the client in response to predefined notification commands received by the client over the network; and
d) providing on the server an interface between the application and the data network which is effective to issue one or more of said notification generation commands in response to notifications of events received from the application;
whereby the server-side service provides a network addressable control service to enable the client to control said application on the server, and the client-side service provides a network addressable notification service to enable the server to notify the client of events occurring in the application.

2. A method as claimed in claim 1, wherein said server-side service and said client-side service are each provided as web services between a provider and a remote consumer, the consumer of the server-side service being the client interface and the consumer of the client-side service being the server interface.

3. A method as claimed in claim 2, wherein the definition of said application control commands is a web services description language (WSDL) file provided on the server.

4. A method as claimed in claim 3, wherein said WSDL file includes said instructions which define said client-side web service.

5. A method as claimed in claim 3, wherein said WSDL file includes instructions for the client to access said instructions which define said client-side web service over the network.

6. A method as claimed in claim 1, wherein said application is a computer telephone integration (CTI) application in communication with a telephony network, whereby the interface on the client enables a user of the client to control a device on said telephony network and the interface on the server enables the CTI application to issue notifications of telephony network events or state changes relating to the device to the user of the client.

7. A method as claimed in claim 1, wherein said data network is a packet switching network employing the transport communication protocol/internet protocol (TCP/IP) method of addressing packets from the client to the server and vice versa.

8. A method as claimed in claim 7, wherein the data network is selected from a local area network, a wide area network, and the Internet.

9. A method as claimed in claim 1, wherein said server is a web server running said application.

10. A method as claimed in claim 1, wherein said server is a web server and said application runs on a computer in communication with said server.

11. A computer program product comprising machine readable instructions which, when executed on a computer which is connected to a data network and which has control of an application, are effective to cause the computer to:
a) provide a network addressable server-side service which executes one or more predefined procedures to control said application in response to predefined application control commands received by the computer over the network;
b) provide a definition of said application control commands, said definition being accessible over the data network by a remote client to enable the remote client to provide an interface which formulates said predefined commands and addresses said commands to the server-side service in response to inputs to the client;
c) provide instructions accessible over the data network by the remote client which define a network addressable client-side service which executes one or more predefined procedures to generate notifications on the client in response to predefined notification commands received by the client over the network; and
d) provide on the computer an interface between the application and the data network which is effective to issue one or more of said notification generation commands in response to notifications of events received from the application; whereby the server-side service provides a network addressable control service to enable the client to control said application on the computer, and the client-side service provides a network addressable notification service to enable the-server to notify the client of events occurring in the application, without maintaining a dedicated communications channel between the remote client and the computer.

12. A server having control over an application and comprising a network connection for enabling the server to connect to a data network, and a storage area for storing instructions which when executed are effective to:
a) provide a network addressable server-side service which executes one or more predefined procedures to control said application in response to predefined application control commands received by the computer over the network;
b) provide a definition of said application control commands, said definition being accessible over the data network by a remote client to enable the remote client to provide an interface which formulates said predefined commands and addresses said commands to the server-side service in response to inputs to the client;
c) provide instructions accessible over the data network by the remote client which define a network addressable client-side service which executes one or more predefined procedures to generate notifications on the client in response to predefined notification commands received by the client over the network; and
d) provide on the computer an interface between the application and the data network which is effective to issue one or more of said notification generation commands in response to notifications of events received from the application;
whereby the server-side service provides a network addressable control service to enable the client to control said application on the computer, and the client-side service provides a network addressable notification service to enable the server to notify the client of events occurring in the application, without maintaining a dedicated communications channel between the remote client and the computer.

13. A method of remotely controlling an application from a client computer across a data network, said application being under the local control of a server on the data network, without maintaining a dedicated communications channel between the client and the server, comprising the steps of:
a) receiving from the server a definition of application control commands which cause a network addressable server-side service to execute one or more predefined procedures to control said application;
b) providing on the client an interface based on said definition which formulates said predefined commands and addresses said commands to the server-side service in response to inputs to the client;
c) receiving instructions over the data network which define a network addressable client-side service which executes one or more predefined procedures to generate notifications on the client in response to predefined notification commands received by the client over the network; and
d) providing on the client said network addressable client-side service which monitors for receipt of said notification generation commands and which generates said notifications on the client in response thereto;
whereby the server-side service provides a network addressable control service to enable the client to control said application on the server, and the client-side service provides a network addressable notification service to enable the server to notify the client of events occurring in the application.

14. A method as claimed in claim 13, wherein said server-side service and said client-side service are each provided as web services between a provider and a remote consumer, the consumer of the server-side service being the client interface and the consumer of the client-side service being the server interface.

15. A method as claimed in claim 14, wherein the definition of said application control commands is a web services description language (WSDL) file provided on the server.

16. A method as claimed in claim 15, wherein said WSDL file includes said instructions which define said client-side web service.

17. A method as claimed in claim 15, wherein said WSDL file includes instructions for the client to access said instructions which define said client-side web service over the network.

18. A method as claimed in claim 13, wherein said application is a computer telephone integration (CTI) application in communication with a telephony network, whereby the interface on the client enables a user of the client to control a device on said telephony network and the interface on the server enables the CTI application to issue notifications of telephony network events or state changes relating to the device to the user of the client.

19. A method as claimed in claim 13, wherein said data network is a packet switching network employing the transport communication protocol/internet protocol (TCP/IP) method of addressing packets from the client to the server and vice versa.

20. A method as claimed in claim 19, wherein the data network is selected from a local area network, a wide area network, and the Internet.

21. A computer program product comprising machine readable instructions which, when executed on a computer which is connected to a data network, are effective to cause the computer to:
a) receive from a server across the network a definition of application control commands which cause a network addressable server-side service to execute one or more predefined procedures to control said application;
b) provide on the computer an interface based on said definition which formulates said predefined commands and addresses said commands to the server-side service in response to inputs to the computer;
c) receive instructions over the data network which define a network addressable client-side service which executes one or more predefined procedures to generate notifications on the computer in response to predefined notification commands received by the computer over the network; and
d) providing on the computer said network addressable client-side service which monitors for receipt of said notification generation commands and which generates said notifications on the computer in response thereto;
whereby the server-side service provides a network addressable control service to enable the computer to control said application on the server, and the client-side service provides a network addressable notification service to enable the server to notify the computer of events occurring in the application, without maintaining a dedicated communications channel between the remote client and the computer.

22. A client computer for providing remote control over an application across a data network, comprising a network connection for enabling the client computer to connect to said data network, and a storage area for storing instructions which when executed are effective to cause the client to:
a) receive from a server across the network a definition of application control commands which cause a network addressable server-side service to execute one or more predefined procedures to control said application;
b) provide on the computer an interface based on said definition which formulates said predefined commands and addresses said commands to the server-side service in response to inputs to the computer;
c) receive instructions over the data network which define a network addressable client-side service which executes one or more predefined procedures to generate notifications on the computer in response to predefined notification commands received by the computer over the network; and
d) providing on the computer said network addressable client-side service which monitors for receipt of said notification generation commands and which generates said notifications on the computer in response thereto;
whereby the server-side service provides a network addressable control service to enable the computer to control said application on the server, and the client-side service provides a network addressable notification service to enable the server to notify the computer of events occurring in the application, without maintaining a dedicated communications channel between the remote client and the computer.

23. A system comprising a client and a server connected across a data network, the client and the server each being provided with a storage area for storing instructions to allow asynchronous interaction between the client and server, and the server having control of an application, wherein:
(I) the storage area of the server stores instructions which when executed are effective to cause the server to:
a) provide a network addressable server-side service which executes one or more predefined procedures to control said application in response to predefined application control commands received by the server over the network;
b) provide a definition of said application control commands, said definition being accessible over the data network by the client to enable the client to 30 provide an interface which formulates said predefined commands and addresses said commands to the server-side service in response to inputs to the client;
c) provide instructions accessible over the data network by the client which define a network addressable client-side service which executes one or more predefined procedures to generate notifications on the client in response to predefined notification commands received by the client over the network; and
d) provide on the server an interface between the application and the data network which is effective to issue one or more of said notification generation commands in response to notifications of events received from the application; and
(II) the storage area of the client stores instructions which when executed are effective to cause the client to:
a) receive from the server across the network said definition of application control commands;
b) provide on the client an interface based on said definition which formulates said predefined commands and addresses said commands to the server-side service in response to inputs to the client;
c) receive over the data network said instructions which define a network addressable client-side service; and
d) provide on the client said network addressable client-side service which monitors for receipt of said notification generation commands and which generates said notifications on the computer in response thereto;
whereby the server-side service provides a network addressable control service to enable the client to control said application on the computer, and the client-side service provides a network addressable notification service to enable the server to notify the client of events occurring in the application, without maintaining a dedicated communications channel between the remote client and the computer.

24. A method of providing an asynchronous interaction between a client and a server, comprising the steps of providing Web Services on the server to be consumed by the client and providing Web Services on the client to be consumed by the server, whereby each of the client and server acts as both a Web Services provider and a Web Services consumer, such that when acting as a consumer each can notify the other of events asynchronously by invoking a Web Services command, and wherein said asynchronous interaction is provided without maintaining a dedicated communications channel.
